(19) United States
(12) Patent Application Publication
(10) Pub. No.: US 2016/0320024 A1
(43) Pub. Date: Nov. 3, 2016

(54) SAFETY LANTERN

(71) Applicant: PHYNEOS LIMITED, Hong Kong (CN)

(72) Inventors: Felix Grimm, Hong Kong, China (CN); Lorenzo Scazziga, Hong Kong, China (CN)

(73) Assignee: Phyneos Limited, Hong Kong (CN)

(21) Appl. No.: 15/105,157

(22) PCT Filed: Dec. 16, 2014
(86) PCT No.: PCT/EP2014/078065

§ 371 Date: Jun. 16, 2016

(30) Foreign Application Priority Data
Dec. 16, 2013 (GB) 1322135.3

(51) Int. Cl. F21V 9/08; F21V 5/04; F21V 15/01; F21V 3/00; F21L 4/00; F21V 7/04; F21V 9/16

(52) U.S. Cl. CPC F21V 9/08; F21V 7/041; F21V 5/04; F21V 9/16; F21V 3/00; F21L 4/00; F21V 15/01

(57) ABSTRACT

A lantern (1) comprising a light emitter (3), a housing (5) circumferentially located around the light emitter (3) and defining a central axis (7), and a collimator (9) located along the central axis, wherein the housing (5), at its circumference, is capable of modifying the visible spectrum of the emitted light.

### TECHNICAL FIELD

The invention relates to lighting devices namely lanterns, and more particularly to handheld flashlights having integrated safety features. The invention also relates to lenses and light emitting diodes for use in lighting devices.

### BACKGROUND OF THE INVENTION

Light emitting diode (LED) light sources are well known in the art. However, until recently, the use of LEDs in directional lighting devices such as flashlights was somewhat held back, because whilst having a high light output compared to their power usage, and a longer lifetime than incandescent light sources, their light output is incoherent and highly divergent. Essentially, light is emitted in all directions and the phase of light waves is not constant relative to each other, which results in a reduction in efficiency as light goes in undesired directions and waves interfere with each other to cancel each other out.

This is a known problem, and one much background art is directed towards solving in many applications, a strong, straight beam of light, collimated and non-divergent, is desirable. In flashlights, a forward-directed beam (relative to the operator) illuminates the operator's path.

One way in which the prior art attempts to address this problem is by using a collimating reflector positioned behind an LED (along the light emitting axis in the opposite direction to which light is desired to be emitted from a lighting device) as in U.S. Pat. No. 6,685,336B1. Later patent applications describe the reflector being of parabolic shape, with the LED at reflector's focal point, as in U.S. Pat. No. 7,798,667. This way, much sideways- and rear-directed light is reflected to emerge from the reflector in a forward direction, with far less divergence. U.S. Pat. No. 7,246,917B2 describes the use of a plurality of reflectors.

Another way in which the prior art attempts to address this problem is by positioning a collimating lens, which are well known in the art, in front of the LED (along the light emitting axis in the direction in which light is desired to be emitted from the lighting device), for example in EP1255132B1. Other inventors have combined reflectors with lenses, such as in US2006152820. All of this has been done in an attempt to increase the efficiency of flashlights by ensuring that as much light as possible emerges in the desired direction of the beam.

Collimators such as lenses and reflectors are not 100% efficient. Not all light desired to be collimated will, in fact, be collimated. Especially, collimators produced at costs suitable for inclusion in flashlights—as opposed to, for example, scientific research—suffer significant leakage, whereby light that is desired to be directed forwards will instead be absorbed by the collimator or escape from the collimator at other angles, for example sideways.

Multi-colour flashlights are known in the art. For example, U.S. Pat. No. 7,896,518 describes the use of switches on a flashlight to cycle through colours. Different colours or wavelengths of light are suited to different tasks—that patent mentions aviation, military and police applications, hunting, and anti-forgery applications of the different colours.

Indeed, the reader is invited to consider the example of an automobile, which is subject to complex regulation of its lights for safety reasons. Headlights are generally white, whilst fog lamps are often required to be selective yellow, that is, having removed some short blue to violet wavelengths from the light source's colour spectrum in order to aid humans' visual processing, reducing dazzle and glare. Tail lamps are generally red to differentiate the front and rear of a vehicle. Conspicuity lights, such as lateral side marker lights are also usually of a different colour, often amber. To other road users, these lights clearly mark out the side of a vehicle from its front or rear, and assist in making the vehicle's presence, position, and direction of travel known to observers at oblique angles.

Lateral side marker lights are also desirable for pedestrians, particularly those walking along dark roads. Such lights will benefit road safety. Existing solutions such as reflective clothing, or childrens' shoes with LEDs inlaid into the soles, are incapable of effectively producing a forward-directed light that is different from a sideways-emitted light. This does little to assist drivers in ascertaining the pedestrian's presence, position, or direction of travel from an oblique angle.

U.S. Pat. No. 4,257,085 describes a warning lantern adapter particularly for use with motor vehicles. This complex piece of equipment is designed to interoperate with an existing independent flashlight, diverting part of its beam and converting a non-diverted part of the beam into unidirectional light. Especially with LEDs where much light is emitted in undesirable directions, this is wasteful of energy compared to simply harvesting a portion of the undesirably directed light and applying it to useful effect.

There is thus a need to design a flashlight capable of producing a forward-directed light of one colour, and a sideways-emitted light of another colour, whilst minimizing manufacturing costs by putting light formerly considered as “wasted” to better use. It is therefore an object of the present invention to improve on the foregoing disadvantages of the existing art, whilst introducing advantageous new functionality.

### SUMMARY OF THE INVENTION

The present invention provides a lantern comprising a light emitter, a housing circumferentially located around the light emitter and defining a central axis, and a collimator located along the central axis, wherein the housing at its circumference is capable of modifying the visible spectrum of the emitted light. Thus in use, the housing modifies the visible spectrum of the emitted light.

In one embodiment, a handle forms one end of the central axis and houses an electric battery. The light emitter and housing are affixed to the handle. In this configuration, the lantern constitutes a flashlight. One or more collimators may be affixed either to the handle or to the housing.

The orientation of the light emitter and collimator define a direction of emission of light along the central axis. When the lantern is a flashlight having a handle, this forward direction would typically be opposed to the handle. The housing may be open at the forward end or it may be enclosed or terminate in a protective cap. Preferably, the forward end is enclosed or terminates in a cap, so as to provide protection to the light emitter and collimator, for example from water and foreign object damage, and transparent allow the maximum amount of light to pass through it and emerge from the lantern. The emerging light in the forward direction would thus be of the same wavelength as emitted from the light emitter.

The circumference of the housing has a means of modifying the visible spectrum of the light so as to change its colour. The modification can be effected by several means, for example by filtering unwanted wavelengths from the emitted light and only passing certain wavelengths, or by an effect such as phosphorescence wherein the emitted light is absorbed by a phosphor in the housing and re-emitted as light of a different wavelength. In a simple, preferred embodiment wherein the housing is a plastic cylinder, the circumference of the cylinder is translucent and coloured by a known method such as adding pigment to the polymer resin. Preferably, the light emitter emits white light and the circumference of the housing is translucent amber. In this manner the lantern produces a forward-directed white light beam and a circumferential, diffuse amber light.

The housing may be broadly cylindrical in shape or another shape such as broadly square or rectangular in profile. The term ‘circumference’ used herein should be read accordingly to refer to the lateral surface or surfaces of the housing.

Preferably the collimator is a cone-shaped reflector. This enables the collimator to be placed co-axially with the housing to increase the amount of light transmitted along the central axis (compared to the light emitted in this direction directly from the light emitter).

More specifically in an embodiment of the present invention, the reflector may be arranged to reflect light emitted from the light emitter in a first direction not parallel to the central axis, to a second direction parallel to the central axis.

However, there are other shapes of collimator which can achieve the same effect as the cone-shaped reflector and accordingly the reflector is preferably arranged to increase the amount of light from the light emitter that is transmitted long the central axis out of the lantern.

The light housing, collimator and housing are preferably positioned relative to each other to generate a beam of emitted light along the central axis.

For a better understanding of the invention and to show how the same may be performed, a preferred embodiment thereof will now be described, by way of non-limiting example only, with reference to the accompanying drawings.

### BRIEF DESCRIPTION OF THE DRAWINGS

Non-limiting examples are described with reference to the following figures, in which:

FIG. 1 shows a side view of a safety lantern according to an embodiment of the present invention;

FIG. 2 shows the same side view of a safety lantern as FIG. 1, additionally picturing illustrative rays of light demonstrating the operation of the lantern;

FIG. 3 shows a side view of a safety lantern according to an alternative embodiment of the invention;

FIG. 4 shows the same side view of a safety lantern as FIG. 3, with an additional collimator and picturing illustrative rays of light demonstrating the operation of the lantern; and

FIG. 5 shows an embodiment of the invention affixed to and forming part of a practical flashlight.

### DESCRIPTION OF PREFERRED EMBODIMENTS

The following description relates in general to a safety lantern system, and in particular those appropriate for handheld operation as flashlights.

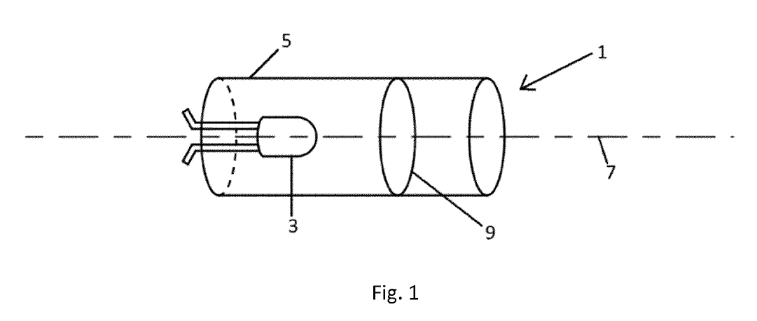

FIG. 1 shows a preferred embodiment of a safety lantern according to the present invention. The safety lantern 1 incorporates a light emitter 3, a housing 5 located circumferentially around the light emitter 3 and defining a central axis 7, and a collimator 9. The housing 5 is, in the preferred embodiment, a plastic cylinder having a coloured translucent circumference, and a transparent closed end. The housing 5 is capable of modifying the colour of the emitted light. In the preferred embodiment as shown, the collimator 9 is a collimating lens.

The central axis 7 defined by the housing 5 has a forward direction towards which emission of light is desirable and a rear direction towards which emission of light is undesirable.

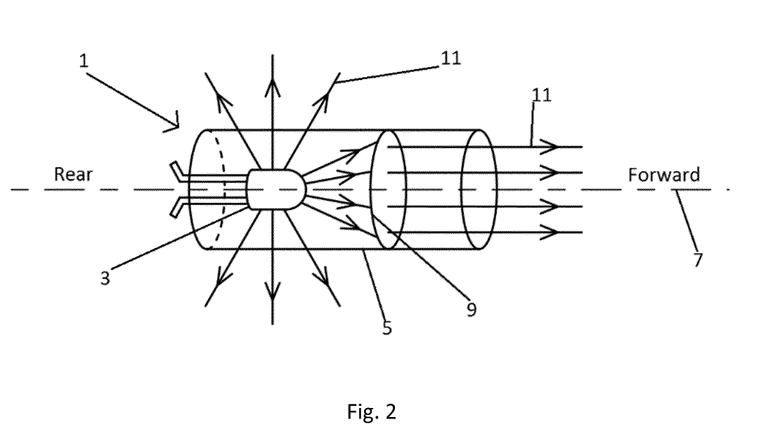

Operation of the device is shown via FIG. 2. The same embodiment of the invention is shown as in FIG. 1, but with the addition of light rays 11. It is apparent that the light rays 11 emitted from the light emitter 3 are incoherent and divergent. A portion of the light 11 passes through a portion of the housing 5, which modifies its constituent spectral components, such that the light rays 11 emerging from the circumference of the housing 5 are a visibly different colour than those emerging from the forward direction of the device.

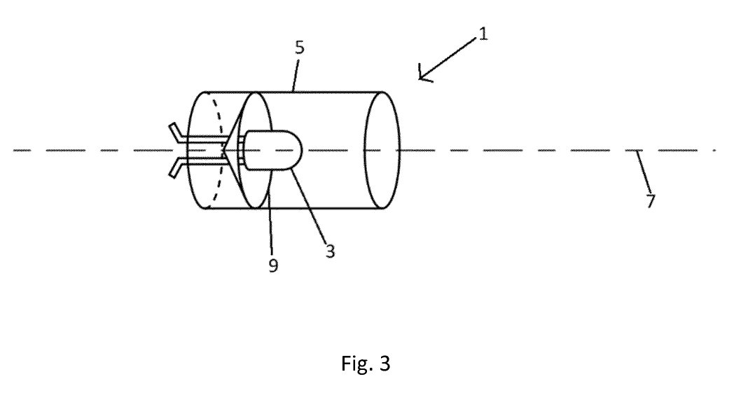

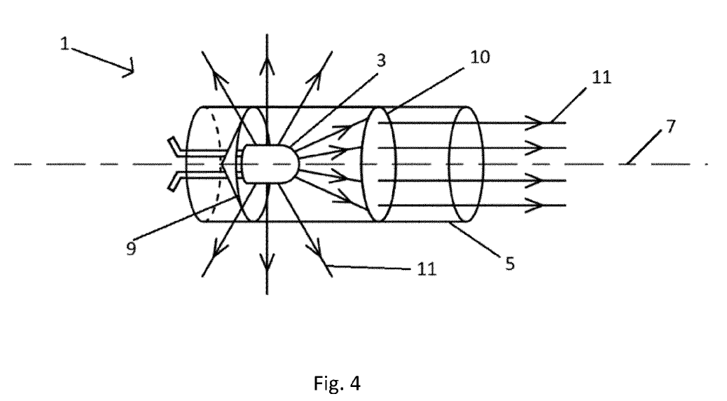

FIG. 3 shows an alternative embodiment of the invention wherein the collimator 9 is a reflector positioned behind the light emitter 3 on the central axis 7 with respect to the desired direction of the emission of the collimated beam. In this embodiment, the collimator 9 reflects and adjusts the angle of light rays such that the majority of light is emitted from the safety lantern 1 in the desired, forward, direction. Some light is still emitted through the housing 5, which modifies its constituent spectral components, such that the light rays 11 emerging from the circumference of the housing 5 are a visibly different colour than those emerging from the forward direction of the device. FIG. 4 shows a preferred embodiment of the invention with an additional collimator 10 and illustrative light rays 11 such that the operation of the device 1 may be readily understood.

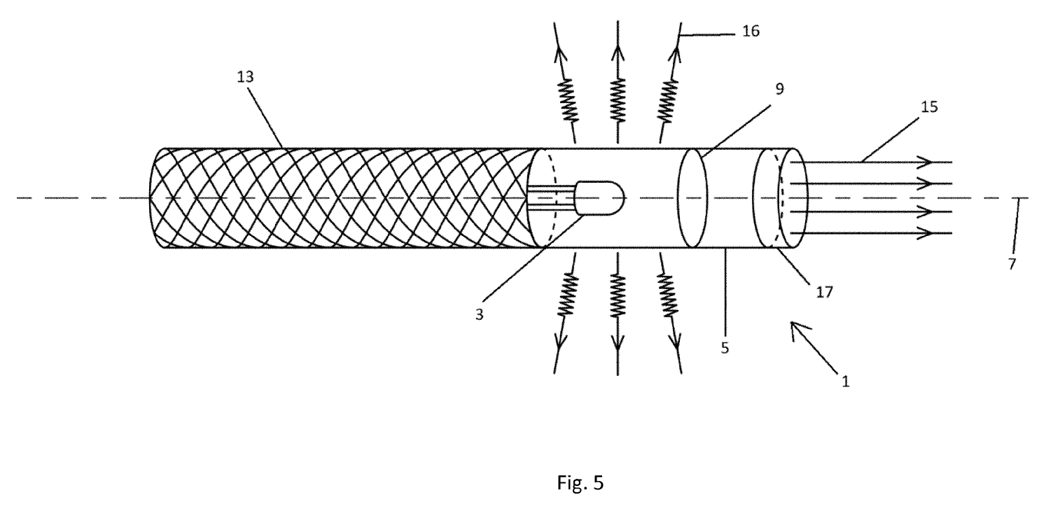

FIG. 5 shows an embodiment of the present invention forming part of a practical flashlight. The safety lantern 1 is affixed to a handle 13 which houses a source of electricity (for example disposable batteries or rechargeable cells) capable of powering the light emitter 3 and may be gripped by an operator. At the forward end of the housing 5 there is a transparent cap 17, which serves to protect the light emitter 3 from damage due to water and foreign objects. The circumference of the housing 5 is coloured, rendering it capable of modifying the spectrum of light 16 emitted circumferentially from the safety lantern 1. Meanwhile, the spectrum of the light 15 emitted from the safety lantern 1 through the transparent cap 17 in the desired, forward, direction remains substantially the same as that of the light emitted by the light emitter 3.

The invention described herein is susceptible to variations, modifications and/or additions other than those specifically described and it is to be understood that the invention includes all such variations, modifications and/or additions, which fall within the spirit and scope of the following claims.

1. A lantern comprising a light emitter, a housing circumferentially located around the light emitter and defining a central axis, and a collimator located along the central axis, wherein the housing, at its circumference, is capable of modifying the visible spectrum of the emitted light.

2. The lantern according to claim 1, wherein the light emitter is a light emitting diode.

3. The lantern according to claim 1, wherein the collimator is a collimating lens.

4. The lantern according to claim 1, wherein the collimator is a reflector.

5. The lantern according to claim 4, wherein the collimator is a cone-shaped reflector.

6. The lantern according to claim 4, wherein the reflector is arranged to reflect light emitted from the light emitter in a first direction not parallel to the central axis, to a second direction parallel to the central axis.

7. The lantern of claim 4, wherein the reflector is arranged to increase the amount of light from the light emitter that is transmitted long the central axis out of the lantern.

8. The lantern of claim 1, wherein the light housing, collimator and housing are positioned relative to each other to generate a beam of emitted light along the central axis.

9. The lantern according to claim 3, wherein the housing at its circumference is a different colour than at least one end of the housing.

10. The lantern according to claim 3, wherein the housing at its circumference is a different colour than the light emitted from the light emitter.

11. The lantern according to claim 1, wherein the housing is translucent.

12. The lantern according to claim 1, wherein the housing acts as an optical filter to filter out certain wavelengths of visible light.

13. The lantern of claim 12, wherein the housing comprises a translucent polymer material including a pigment.

14. The lantern according to claim 1, wherein the housing comprises a phosphor which is arranged to absorb the emitted light and re-emit the absorbed light at a different wavelength.

15. The lantern according to claim 1, wherein the lantern comprises a plurality of collimators.

16. A flashlight comprising a lantern according to claim 1, wherein the flashlight further comprises a handle at one end of the central axis housing an electric battery compartment.

17. A flashlight according to claim 16, wherein the housing comprises a transparent cap at one end of the housing opposed to the handle.
